(19) United States
(12) Patent Application Publication
(10) Pub. No.: US 2026/0141871 A1
(43) Pub. Date: May 21, 2026

(54) CIRCUIT SUBSTRATE, ELECTROWETTING DEVICE USING THE SAME, AND CONTROL CIRCUIT

(71) Applicants: Sharp Kabushiki Kaisha, Sakai City (JP); Sharp Display Technology Corporation, Kameyama City (JP)

(72) Inventors: Takeshi HARA, Sakai City (JP); Kohhei TANAKA, Kameyama City (JP); Fumiki NAKANO, Kameyama City (JP)

(21) Appl. No.: 19/335,730

(22) Filed: Sep. 22, 2025

(30) Foreign Application Priority Data
Nov. 19, 2024 (JP) 2024-201264
Mar. 18, 2025 (JP) 2025-044055

(51) Int. Cl. G09G 3/34; G09G 3/00

(52) U.S. Cl. CPC G09G 3/348; G09G 3/006; G09G 2300/0426; G09G 2330/12

(57) ABSTRACT

A circuit substrate includes a control circuit including an input transistor, an output transistor, and an output node, in which in the control circuit, a current corresponding to input to one conduction terminal of the input transistor flows to the output node via the output transistor, and the control circuit includes an inspection circuit element connected to the other conduction terminal of the input transistor and the output node.

### CROSS-REFERENCE TO RELATED APPLICATIONS

This application claims the benefit of priority to Japanese Patent Application Number 2025-044055 filed on Nov. 19, 2024. The entire contents of the above-identified application are hereby incorporated by reference.

### BACKGROUND

### Technical Field

The disclosure relates to a circuit substrate, an electrowetting device using the circuit substrate, and a control circuit.

JP 2003-228299 A discloses a method of determining whether a display device is non-defective. Further, JP 2020-42261 A discloses an electrowetting on dielectric device (EWOD) using an active matrix substrate.

### SUMMARY

For example, a circuit substrate (active matrix substrate) used in an electrowetting device has a problem that whether the circuit substrate is non-defective cannot be determined before the circuit substrate is incorporated into a target device. Further, since an operation cannot be confirmed unless a conductive liquid is injected between the circuit substrate and a counter substrate, even when a current leak failure occurs during actual use, the current leak failure cannot be detected.

A circuit substrate according to an aspect of the disclosure is a circuit substrate including a control circuit including an input transistor, an output transistor, and an output node, in which one conduction terminal of the input transistor is connected to a control terminal of the output transistor, one conduction terminal of the output transistor is connected to the output node, and the circuit substrate includes an inspection circuit element connected to the output node.

A circuit substrate used in an electrowetting device according to an aspect of the disclosure includes a control circuit including an input transistor, an output transistor, and an output node, in which in the control circuit, a current corresponding to input to the one conduction terminal of the input transistor flows to the output node via the output transistor, and the control circuit includes an inspection circuit element connected to the output node.

Electrowetting is a phenomenon in which, when an electric field is applied to a droplet (conductive liquid), which is arranged on a water-repellent dielectric layer provided on an electrode, a contact angle of the droplet with respect to the dielectric layer is changed. Through use of the electrowetting, for example, a fine droplet can be manipulated.

According to an aspect of the disclosure, whether a circuit substrate is non-defective can be determined before the circuit substrate is incorporated into the electrowetting device. In addition, even when a defect occurs after the circuit substrate is incorporated into the electrowetting device, the defect can be detected.

### BRIEF DESCRIPTION OF DRAWINGS

The disclosure will be described with reference to the accompanying drawings, wherein like numbers reference like elements.

FIG. 1 is a schematic view illustrating configurations of a control circuit, a circuit substrate, and an electrowetting device including the control circuit and the circuit substrate according to the present embodiment.

FIG. 2 is a schematic view illustrating configurations of a control circuit, a circuit substrate, and an electrowetting device including the control circuit and the circuit substrate according to the present embodiment.

FIG. 3 is a cross-sectional view of the electrowetting device including the circuit substrate.

FIG. 4 is an overall view of a circuit substrate.

FIG. 5 is a plan view of a glass substrate.

FIG. 6 is a schematic cross-sectional view of the circuit substrate.

FIG. 7 is a circuit diagram of an equivalent circuit of a control circuit provided on a circuit substrate according to a first embodiment.

FIG. 8 is a circuit diagram for explaining an operation of an equivalent circuit of a control circuit.

FIG. 9 is a circuit diagram of an equivalent circuit of the control circuit according to a first modified example.

FIG. 10 is a circuit diagram for explaining an operation of the equivalent circuit of the control circuit according to the first modified example.

FIG. 11 is a circuit diagram of an equivalent circuit of the control circuit according to a second modified example.

FIG. 12 is a circuit diagram for explaining an operation of the equivalent circuit of the control circuit according to the second modified example.

FIG. 13 is a circuit diagram of an equivalent circuit of the control circuit according to a third modified example.

FIG. 14 is a circuit diagram for explaining an operation of the equivalent circuit of the control circuit according to the third modified example.

FIG. 15 is a circuit diagram of an equivalent circuit of a control circuit provided on a circuit substrate according to a second embodiment.

FIG. 16 is a circuit diagram for explaining an operation of an equivalent circuit of the control circuit.

FIG. 17 is a circuit diagram of an equivalent circuit of the control circuit according to a fourth modified example.

FIG. 18 is a circuit diagram for explaining an operation of the equivalent circuit of the control circuit according to the fourth modified example.

FIG. 19 is a circuit diagram of an equivalent circuit of the control circuit according to a fifth modified example.

FIG. 20 is a circuit diagram for explaining an operation of the equivalent circuit of the control circuit according to the fifth modified example.

FIG. 21 is a circuit diagram of an equivalent circuit of the control circuit according to a sixth modified example.

FIG. 22 is a circuit diagram for explaining an operation of the equivalent circuit of the control circuit according to the sixth modified example.

### DESCRIPTION OF EMBODIMENTS

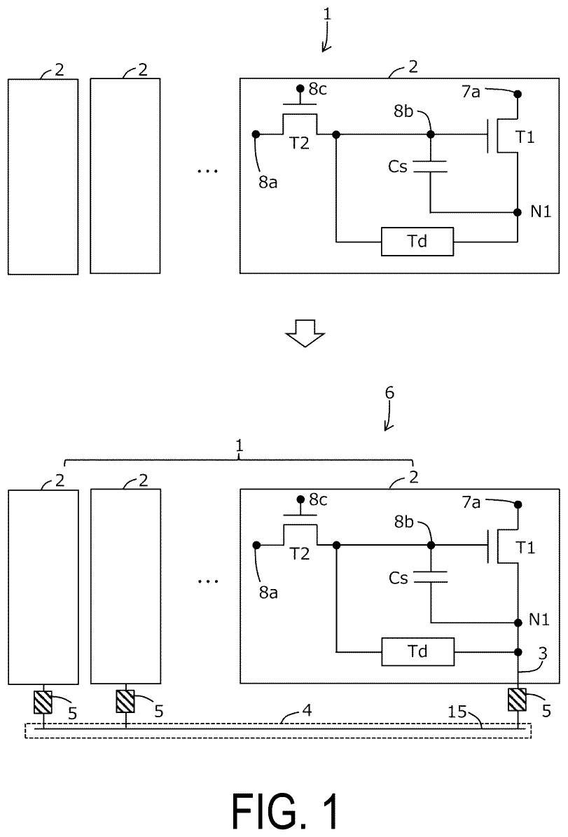

FIG. 1 is a circuit diagram illustrating a configuration example of a circuit substrate and an electrowetting device including the circuit substrate according to the present embodiment. As illustrated in FIG. 1, a circuit substrate 1 according to the present embodiment includes a control circuit 2 including an input transistor T2, an output transistor T1, a holding capacitor Cs, and an inspection circuit element Td. The control circuit 2 includes a first terminal 7a, a second terminal 8a, a third terminal 8c, and an output node N1. The inspection circuit element Td may include at least one of a wiring line, a resistor, a capacitor, or a transistor. One of two conduction terminals of the output transistor T1 is connected to the first terminal 7a, and the other is connected to the output node N1. One of two conduction terminals of the input transistor T2 is connected to the second terminal 8a, the other conduction terminal 8b is connected to a control terminal of the output transistor T1, and the control terminal is connected to the third terminal 8c. When a power supply voltage is input to the first terminal 7a, a data signal is input to the second terminal 8a, and a scanning signal is input to the third terminal 8c, a current corresponding to the magnitude of the data signal input to the second terminal 8a flows to the output node N1 via the output transistor T1. The inspection circuit element Td and the holding capacitor Cs are connected to the other conduction terminal 8b of the input transistor T2 and the output node N1. The circuit substrate 1 includes a control circuit group including a plurality of the control circuits 2.

An electrowetting device 6 includes the circuit substrate 1 including the plurality of control circuits 2, element electrodes 3 (e.g., anodes) connected to output nodes N1, a counter substrate 4 including a counter electrode 15 (e.g., a cathode), and conductive liquids 5 injected between the circuit substrate 1 and the counter substrate 4. When used as the electrowetting device 6, all or some of the inspection circuit elements Td may be removed, or the inspection circuit element Td may be left. In the electrowetting device 6, by supplying the data signal to the second terminal 8a while applying the on voltage to the third terminal 8c, a voltage corresponding to the data signal is written to the control terminal of the output transistor T1. That is, by supplying a high potential voltage to the first terminal 7a and a low potential voltage to the counter electrode 15, a current corresponding to the data signal is applied from the first terminal 7a to the conductive liquid 5 via the output transistor T1, the output node N1, and the element electrode 3. Accordingly, an electrical field corresponding to the data signal is generated, and an apparent contact angle of the droplet (conductive liquid 5) can be controlled according to the magnitude of the electrical field. By setting the magnitude of the electrical field for each of a plurality of the element electrodes 3, a manipulation of the droplet can be controlled.

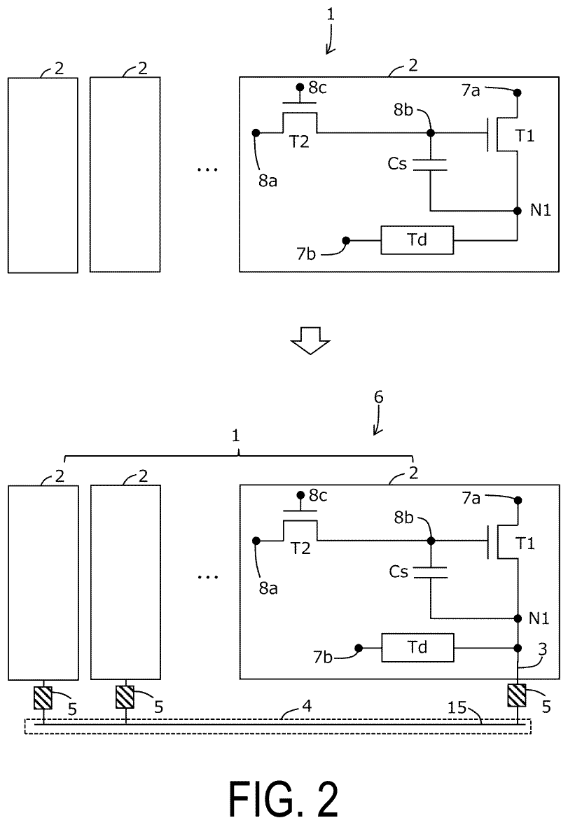

FIG. 2 is a configuration example of another circuit substrate and an electrowetting device including another circuit substrate according to the present embodiment. As illustrated in FIG. 2, the circuit substrate 1 according to the present embodiment includes the control circuit 2 including the input transistor T2, the output transistor T1, the holding capacitor Cs, and the inspection circuit element Td. The control circuit 2 includes the first terminal 7a, the second terminal 8a, the third terminal 8c, a fourth terminal 7b and the output node N1. The output transistor T1, the input transistor T2, and the holding capacitor Cs are connected to the same terminals as those in FIGS. 1 and 2, and perform the same operation as that in FIG. 1. The circuit substrate 1 includes a control circuit group including the plurality of control circuits 2.

The inspection circuit element Td may include at least one of a resistor, a capacitor, or a transistor, and is connected to the fourth terminal 7b (monitoring terminal) and the output node N1.

The electrowetting device 6 includes a circuit substrate 1, a conductive liquid 5 and a counter substrate 4 including a counter electrode 15 (e.g., a cathode) and operates in a similar manner as in FIG. 1.

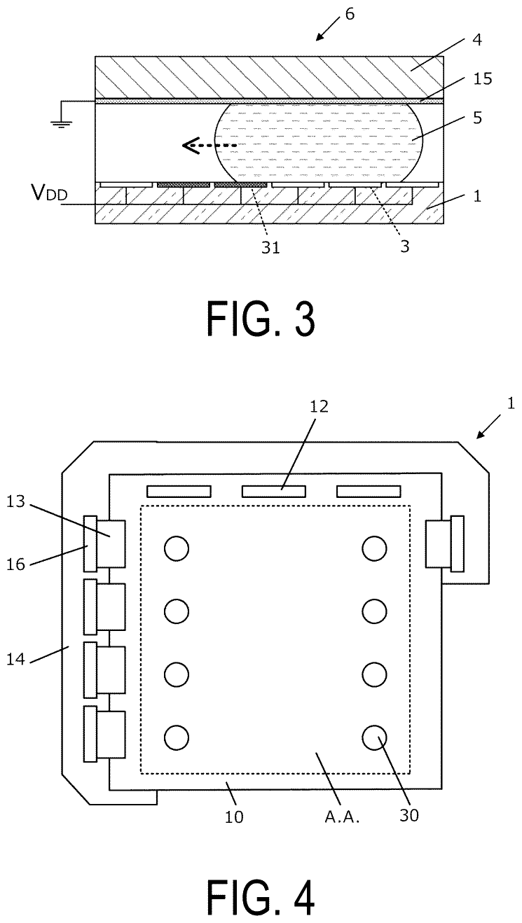

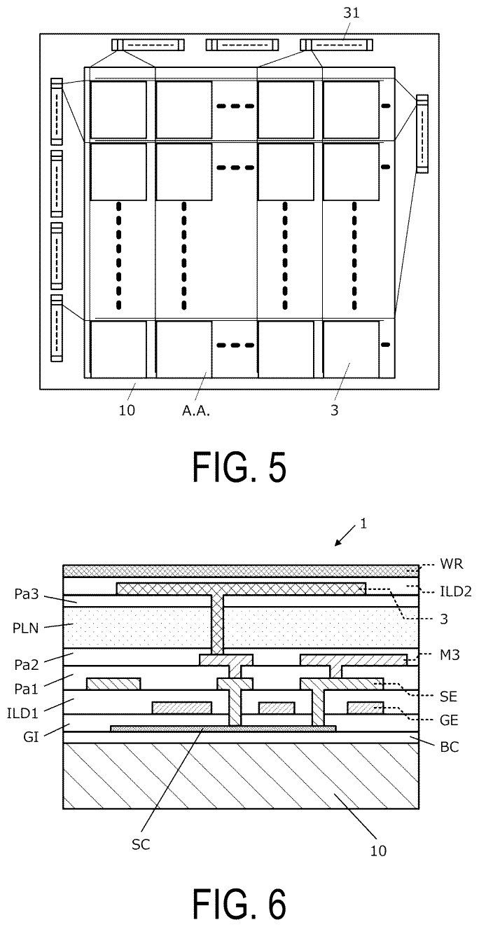

FIG. 3 is a cross-sectional view of the electrowetting device. FIG. 4 is an overall view of the circuit substrate. FIG. 5 is a plan view of a glass substrate. FIG. 6 is a schematic cross-sectional view of the glass substrate. As illustrated in FIG. 3, the electrowetting device 6 includes the circuit substrate 1 including the element electrodes 3, the counter substrate 4 facing the circuit substrate 1, and the conductive liquid 5 disposed between the circuit substrate 1 and the counter substrate 4. As illustrated in FIG. 4, the counter substrate 4 includes a cathode electrode 15 (counter electrode) facing the element electrodes 3, and injection ports 30 for injecting the conductive liquids 5. An air layer may be formed between the circuit substrate 1 and the counter substrate 4, or a non-conductive liquid which is not mixed with the conductive liquid 5 may fill a space between the circuit substrate 1 and the counter substrate 4.

When a current corresponding to the data signal to the second terminal 8a of the control circuit 2 is applied to an element electrode 31 via the output node N1, an electrical field is generated, and a contact angle of the droplet (conductive liquid 5) changes, thereby enabling the droplet to be manipulated.

As illustrated in FIGS. 4 and 5, the circuit substrate 1 includes a glass substrate 10, semiconductor chips 12, chip on film (COF) 13, and a printed circuit substrate (PCB) 14. The semiconductor chip 12 is mounted on the glass substrate 10 by chip on glass (COG). The glass substrate 10 and the PCB 14 are connected to each other via the COF 13 and a connector 16.

As illustrated in FIG. 6, on the upper surface of the glass substrate 10, wiring lines and thin film transistors (TFTs) are formed, and the control circuits 2 and the element electrodes 3 are arranged in an array. Further, connection terminals 31 for mounting the semiconductor chips 12 or the COF 13 are formed.

As the conductive liquid 5, an ionic liquid, a polar liquid, or the like is used. As the conductive liquid, for example, water, electrolytic solution (electrolyte water solution), alcohols, and various types of ionic liquids may be used. As examples of such liquids, a whole blood specimen, a bacterial cell suspension, a protein or antibody solution, and various types of buffer solutions are exemplified. When used in a device (FET sensor, biosensor, etc.) that actively controls an electrochemical reaction of the ionic liquid by current driving, the ionic liquid may be an acid solution such as a sulfuric acid, a hydrochloric acid, a nitric acid, or the like, and may further include a metal ion. In the case of being used in a device (cell potential sensor or the like) that actively reads an electrical field in a solution from the conductive liquid, an electrolytic solution suitable for the application may be used.

The circuit substrate 1 illustrated in FIG. 6 can be manufactured, for example, by the following process.

First, SiO/SiNx films of a base coat film BC having thicknesses of 100 nm/100 nm, respectively, is formed on the glass substrate 10 by a chemical vapor deposition (CVD) apparatus, Si of a silicon film SC having a thickness of 40 nm is formed thereon, and then dehydrogenation annealing and laser annealing are performed to pattern the silicon film SC. After SiO of a gate insulating film GI having a thickness of 100 nm is formed on the silicon film SC by a CVD apparatus, an MoW film of a gate electrode GE having a thickness of 300 nm is formed by a sputtering apparatus, and the gate electrode GE is patterned.

Then, after the silicon film SC is subjected to a lightly doped drain (LDD) doping process and a heavily doped drain (ND) doping process, SiO/SiNx films of a first interlayer insulating layer ILD1 having thicknesses of 700 nm/200 nm, respectively, is formed on the gate electrode GE by a CVD apparatus, and after contact holes for connection are formed in the first interlayer insulating layer ILD1, Ti/Al/Ti films of a source electrode SE having thicknesses of 30 nm/300 nm/20 nm, respectively, is formed by a sputtering apparatus, and the source electrode SE is patterned.

Subsequently, a SiNx film of a first passivation layer Pa1 having a thickness of 300 nm is formed on the source electrode SE by a CVD apparatus, and after contact holes are formed in the first passivation layer Pa1, Ti/Al/Ti films of a first metal layer M3 having thicknesses of 100 nm/600 nm/20 nm, respectively, is formed by a sputtering apparatus, and the first metal layer M3 is patterned.

Thereafter, SiO/siNx films of a second passivation layer Pa2 having thicknesses of 400 nm/150 nm, respectively, are formed on the first metal layer M3 by a CVD apparatus, and a flattened layer PLN having a thickness of 2 μm is formed thereon and patterned by photolithography. The flattened layer PLN may be made of an acrylic or polyimide resin material, and preferably has photosensitivity.

Then, a SiNx film of a third passivation layer Pa3 having a thickness of 100 nm is formed on the flattened layer PLN by a CVD apparatus, and a contact hole is formed in the third passivation layer Pa3 and the second passivation layer Pa2.

Subsequently, a Ti film of the element electrode 3 having a thickness of 300 nm is formed on the third passivation layer Pa3 by a sputtering apparatus and patterned.

Thereafter, a SiNx film of a second interlayer insulating layer IDL2 having a thickness of 100 nm is formed on the element electrode 3, and a SiNx film of the connection terminal 31 is removed. Subsequently, a water-repellent layer WR is formed. The water-repellent layer WR is formed by a fluorine-based resin layer having a functional group at a terminal and having a thickness from 30 nm to 100 nm. Through use of a fluorine-based resin solution (including a fluorine-based resin solvent), the fluorine-based resin layer may be formed by a publicly known method. In order to improve removal of the solvent and/or stability of the fluorine-based resin, heat treatment at approximately from 170° C. to 200° C. is preferably performed. Further, before the fluorine-based resin layer is formed, a silane coupling agent treatment or a fluorine-based primer treatment may be processed. It is preferable that the water-repellent layer WR is not formed in a region where an adhesive for bonding the counter substrate is formed or on the connection terminal 31. For example, after the fluorine-based resin film is formed on the entire surface of the substrate, an opening may be formed at the sealing portion and the connection terminal 31 by a photolithography process.

The gate electrode GE, the source electrode SE, the first metal layer M3, and the element electrode 3 may be made of any combination of Mo, Al, Ti, and W, or alloys thereof. The element electrode 3 may be made of a conductive transparent material such as ITO or IZO.

The base coat film BC has a layered structure of the SiO/SiNx films, but may have a single layer structure of a SiO film or a SiNx film.

Although low temperature polycrystalline silicon (LTPS) is used for the TFT, both P-type and N-type TFTs may be used, or a circuit configuration using one of P-type and N-type TFTs may be employed. The semiconductor layer may be made of an oxide semiconductor (for example, indium gallium zinc oxide) or a-Si.

### First Embodiment

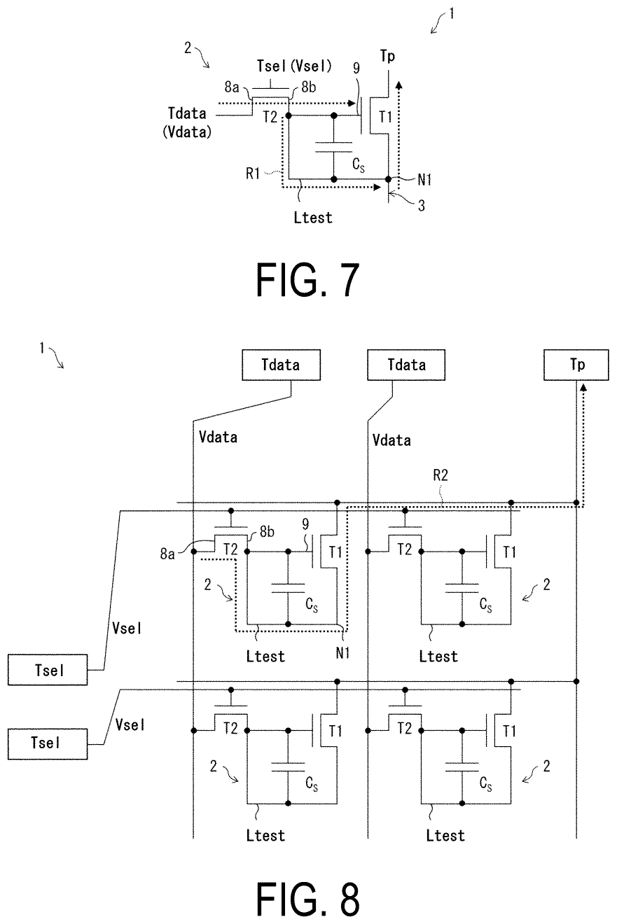

FIG. 7 is a circuit diagram of an equivalent circuit of a control circuit provided on a circuit substrate according to a first embodiment. Constituent elements similar to the constituent elements described above are denoted by the same reference signs and numerals, and detailed descriptions thereof will not be repeated.

The circuit substrate 1 includes the control circuit 2. The control circuit 2 includes the input transistor T2, the output transistor T1, the holding capacitor Cs, and an inspection wiring line Ltest. The control circuit 2 further includes a first terminal Tp, a second terminal Tdata, a third terminal Tsel, and the output node N1.

One of two conduction terminals of the output transistor T1 is connected to the first terminal Tp, and the other is connected to the output node N1. One of the two conduction terminals of the input transistor T2 is connected to the second terminal Tdata, the other conduction terminal 8b is connected to a control terminal 9 of the output transistor T1, and a control terminal is connected to the third terminal Tsel. One terminal of the holding capacitor Cs is connected to the control terminal 9 of the output transistor T1 and the other terminal is connected to the output node N1. The inspection wiring line Ltest is connected to the conduction terminal 8b and the output node N1.

When providing the inspection wiring line Ltest, by applying a voltage Vsel and a voltage Vdata to the third terminal Tsel and the second terminal Tdata, respectively, the input transistor T2 and the output transistor T1 are turned on and a current is generated in a route indicated by an arrow R1 of a dotted line. Thus, the voltage Vdata is applied to the input transistor T2, the inspection wiring line Ltest, and the output transistor T1 in this order, and at least one of a voltage or a current can be measured at the first terminal Tp. In response to the measurement result, it is possible to detect whether the wiring line and the transistor of the control circuit 2 are normal (presence or absence of defects).

When the inspection wiring line Ltest is used as the electrowetting device 6, it is desirable to cause no current flow or make the current as small as possible, and thus, the following steps may be performed.

For example, after the inspection is finished, a step (photolithography, etching, and peeling treatment) of removing the wiring line material of the inspection wiring line Ltest is performed. This step may also serve as a step of patterning the first metal layer M3 and the element electrode 3. The disclosure is not limited to this, and the inspection wiring line Ltest may be cut by laser trimming.

FIG. 8 is a circuit diagram for explaining an operation of the control circuits 2 arranged in an array. In FIG. 8, the inspection wiring line Ltest is added to each of the plurality of control circuits 2. By applying the voltage Vsel and the voltage Vdata to the third terminal Tsel and the second terminal Tdata, respectively, the input transistor T2 and the output transistor T1 are turned on, and a current flow along a route indicated by a route R2 of a dotted line, and a current value can be measured from the first terminal Tp, and it is possible to detect whether the wiring line and the transistor of the control circuit 2 are normal (presence or absence of defects). When the first terminal Tp is used as the electrowetting device 6, a power supply voltage (for example, Vdd) is supplied to the first terminal Tp.

By sequentially switching the third terminals Tsel and the second terminals Tdata to which the voltage Vsel and the voltage Vdata are applied, respectively, all the control circuits 2 arranged in an array can be sequentially inspected.

In FIG. 8, the first terminal Tp is connected to all the control circuits 2, but for example, by providing a plurality of the first terminals Tp so as to be connected to each of all the control circuits 2 in each column direction, it is possible to simultaneously inspect the plurality of control circuits 2, and it is possible to shorten the inspection time.

### First Modified Example According to First Embodiment

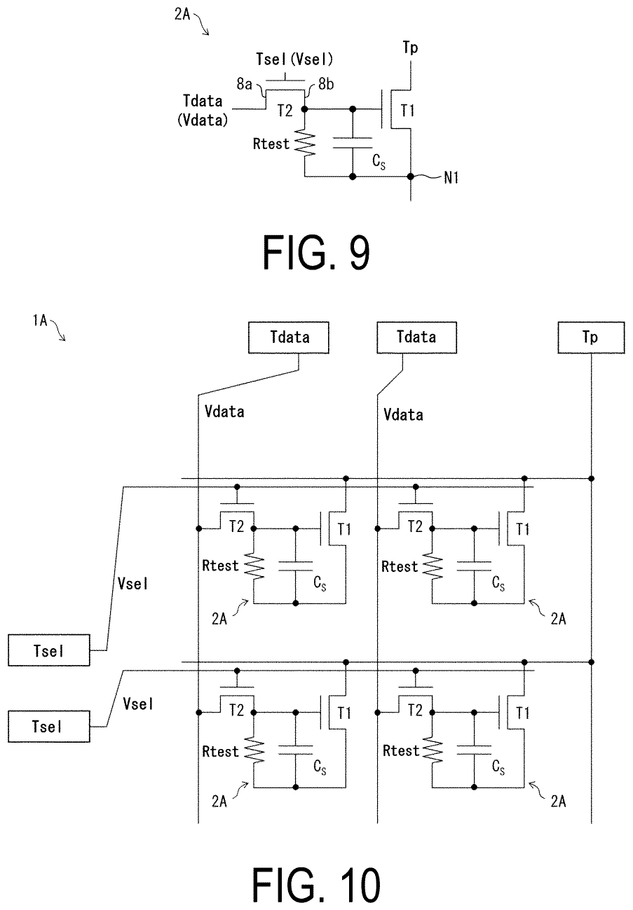

FIG. 9 is a circuit diagram of an equivalent circuit of a control circuit 2A according to a first modified example. FIG. 10 is a circuit diagram for explaining an operation of the control circuits 2A arranged in an array according to the first modified example.

As illustrated in FIG. 9, the control circuit 2A includes, instead of the inspection wiring line Ltest described above with reference to FIG. 7, an inspection resistor Rtest having one end connected to the conduction terminal 8b and the other end connected to the output node N1.

As described above, by increasing the resistance of the connection between the conduction terminal 8b of the input transistor T2 and the output node N1, when used as the electrowetting device 6, only a current at a level that does not cause any problem in operation can flow through the inspection resistor Rtest. When used for inspection, by adjusting the voltage Vdata, a current can flow through the inspection resistor Rtest. The inspection resistor Rtest may be removed after the inspection is completed.

The resistance value of the inspection resistor Rtest can be adjusted by reducing the wiring line width, increasing the wiring line length, changing the wiring line material to a high-resistance material, or the like.

In FIG. 10, by applying the voltage Vsel and the voltage Vdata to the third terminal Tsel and the second terminal Tdata, respectively, the input transistor T2 and the output transistor T1 are turned on, and a current flows from the second terminal Tdata to the first terminal Tp via the inspection resistor Rtest. Thus, the current value can be measured from the first terminal Tp, and it is possible to detect whether the wiring line and the transistor of the control circuit 2A are normal (presence or absence of defects).

### Second Modified Example According to First Embodiment

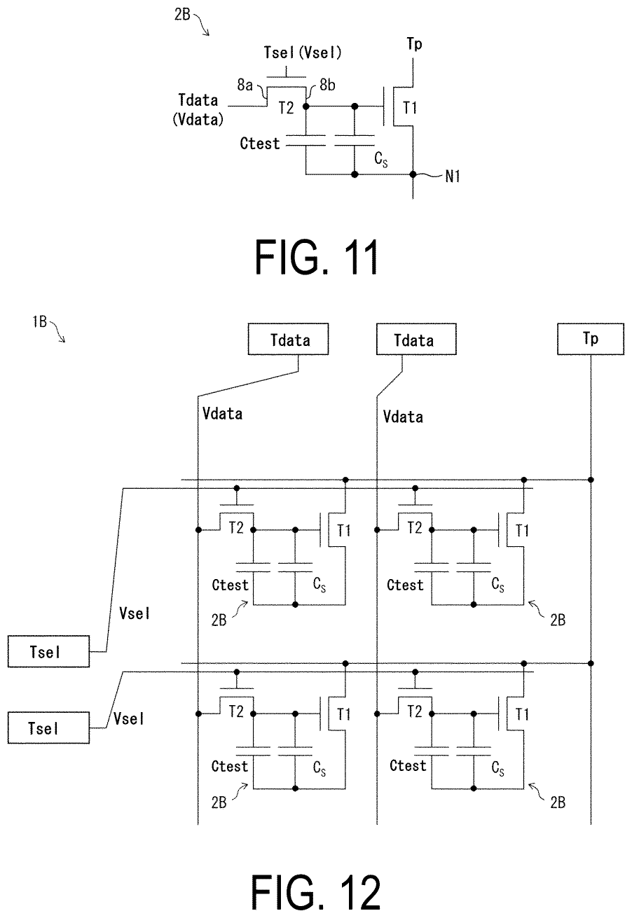

FIG. 11 is a circuit diagram of an equivalent circuit of a control circuit 2B according to a second modified example. FIG. 12 is a circuit diagram for explaining an operation of the control circuits 2B arranged in an array according to the second modified example.

As illustrated in FIG. 11, the control circuit 2B includes, instead of the inspection wiring line Ltest described above with reference to FIG. 7, an inspection capacitor Ctest including one electrode connected to the conduction terminal 8b and the other electrode connected to the output node N1.

As described above, the inspection capacitor Ctest is formed for connection between the conduction terminal 8b of the input transistor T2 and the output node N1, and the capacitance value of the inspection capacitor Ctest and the frequency of the signal of the voltage Vdata are adjusted. In this way, when used as the electrowetting device 6, the capacitance value or the frequency is set so that no current flows through the inspection capacitor Ctest, and during inspection, the capacitance value or the frequency is set so that a current flows through the inspection capacitor Ctest. The capacitance value of the inspection capacitor Ctest can be adjusted by the size of the capacitance electrode and the thickness or the material of the insulating film between the capacitance electrodes.

In FIG. 12, by applying the voltage Vsel to the third terminal Tsel and inputting the voltage signal Vdata having a predetermined frequency (a frequency that can easily pass through the inspection capacitor Ctest as compared with the holding capacitor Cs) to the second terminal Tdata, the input transistor T2 and the output transistor T1 are turned on, and a current flows from the second terminal Tdata to the first terminal Tp via the inspection capacitor Ctest. Thus, the current value can be measured from the first terminal Tp, and it is possible to detect whether the wiring line and the transistor of the control circuit 2B are normal (presence or absence of defects).

### Third Modified Example According to First Embodiment

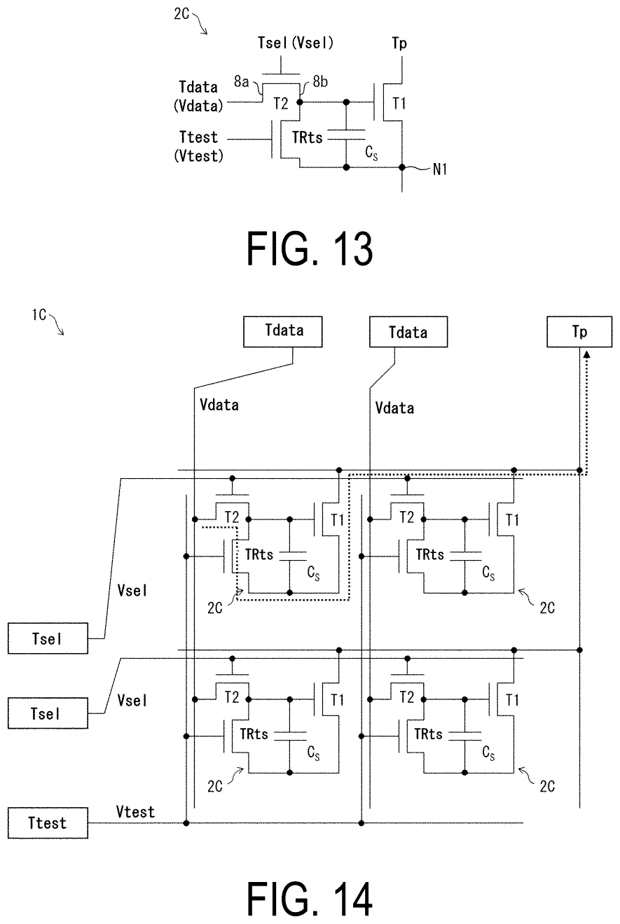

FIG. 13 is a circuit diagram of an equivalent circuit of a control circuit 2C according to a third modified example. FIG. 14 is a circuit diagram for explaining an operation of the control circuits 2C arranged in an array according to the third modified example.

As illustrated in FIG. 13, the control circuit 2C includes, instead of the inspection wiring line Ltest described above with reference to FIG. 7, an inspection transistor TRts including one conduction terminal connected to the conduction terminal 8b, the other conduction terminal connected to the output node N1, and a control terminal connected to a fifth terminal Ttest.

As described above, by connecting the conduction terminal 8b of the input transistor T2 and the output nodes N1 to each other via the inspection transistor TRts, during inspection, the inspection is performed in a state where the inspection transistor TRts is turned on, and when used as the electrowetting device 6, the inspection transistor TRts is turned off so that no current flows.

The inspection transistor TRts can be formed simultaneously with the output transistor T1 and the input transistor T2.

In FIG. 14, by applying the voltage Vsel and the voltage Vdata to the third terminal Tsel and the second terminal Tdata, respectively, in a state where by applying the voltage Vtest to the fifth terminal Ttest first, the inspection transistor TRts is turned on, the input transistor T2 and the output transistor T1 are turned on, and a current flows from the second terminal Tdata to the first terminal Tp via the inspection transistor TRts. Thus, the current value can be measured from the first terminal Tp, and it is possible to detect whether the wiring line and the transistor of the control circuit 2C are normal (presence or absence of defects).

### Second Embodiment

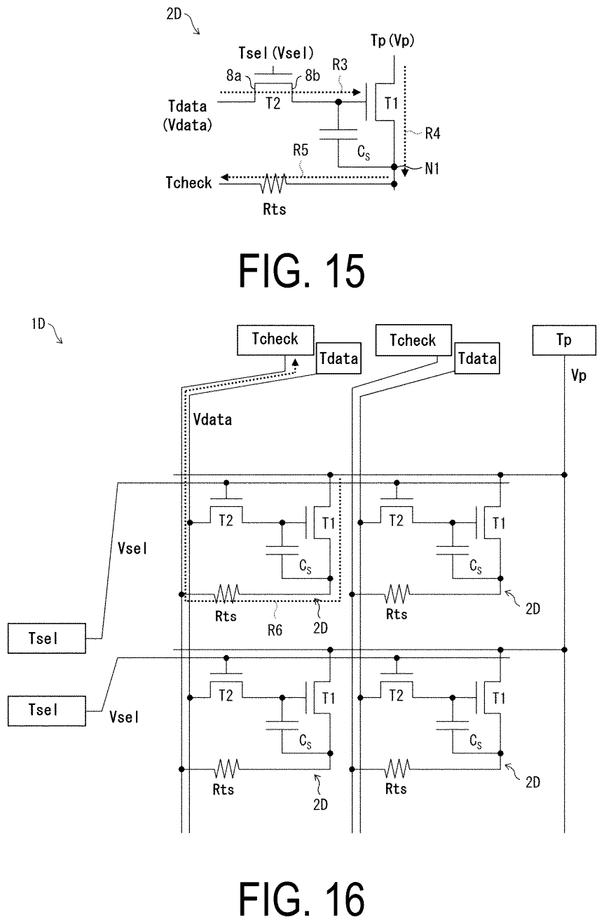

FIG. 15 is a circuit diagram of an equivalent circuit of a control circuit 2D according to a second embodiment. FIG. 16 is a circuit diagram for explaining an operation of the control circuits 2D arranged in an array.

As illustrated in FIG. 15, the control circuit 2D includes the input transistor T2, the output transistor T1, the holding capacitor Cs, and an inspection resistor Rts (inspection circuit element). The control circuit 2D further includes the first terminal Tp, the second terminal Tdata, the third terminal Tsel, a fourth terminal Tcheck, and the output node N1. In the control circuit 2D, a current corresponding to input to one conduction terminal 8a of the input transistor T2 flows to the output node N1 via the output transistor T1. The inspection resistor Rts connects the fourth terminal Tcheck and the output node N1 to each other.

By applying the voltage Vsel and the voltage Vdata to the third terminal Tsel and the second terminal Tdata, respectively, the output transistor T1 and the input transistor T2 are turned on. Then, by applying a voltage Vp to the first terminal Tp, a current flows through a route R4 and a route R5. Thus, at least one of a voltage or a current value of the fourth terminal Tcheck can be measured, and it is possible to detect whether the wiring line and the transistor of the control circuit 2D are normal (presence or absence of defects).

When used as the electrowetting device 6, it is necessary to cause current not to flow through the inspection resistor Rts (or make the current as small as possible). Alternatively, the inspection resistor Rts may be removed by the method described in the first embodiment.

In the case where the inspection resistor Rts is not removed, when used as the electrowetting device 6, it is possible to monitor a change in the current value due to the occurrence of a defect or deterioration in transistor characteristics. In particular, since the control circuit 2D is used in the conductive liquid 5, there is a possibility that a defect may occur due to damage caused by permeation of the conductive liquid 5, and thus, a monitoring function at the fourth terminal Tcheck is important.

In FIG. 16, by applying the voltage Vsel and the voltage Vdata to the third terminal Tsel and the second terminal Tdata, respectively, while applying the voltage Vp to the first terminal Tp, the input transistor T2 and the output transistor T1 are turned on, a current flows through a route R6 from the first terminal Tp to the fourth terminal Tcheck via the output transistor T1 and the inspection resistor Rts, and by measuring at least one of a voltage or a current value of the fourth terminal Tcheck, it is possible to detect whether the wiring line and the transistor of the control circuit 2D are normal (presence or absence of defects).

By sequentially switching the third terminals Tsel and the second terminals Tdata to which the voltage Vsel and the voltage Vdata are applied, respectively, all the control circuits 2D included in the circuit substrate 1D can be sequentially inspected.

The fourth terminal Tcheck in FIG. 16 is connected to the plurality of control circuits 2D arranged in the column direction, but may be connected to the plurality of control circuits 2D arranged in the row direction, or may be drawn out from each of the plurality of control circuits 2D.

### Fourth Modified Example According to Second Embodiment

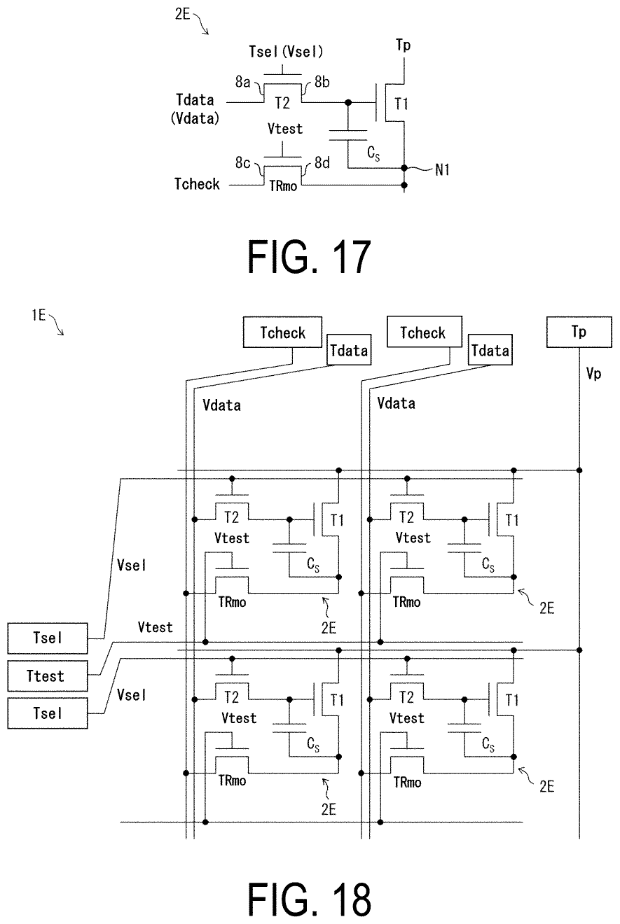

FIG. 17 is a circuit diagram of an equivalent circuit of a control circuit 2E according to a fourth modified example. FIG. 18 is a circuit diagram for explaining an operation of the control circuits 2E arranged in an array according to the fourth modified example.

As illustrated in FIG. 17, the control circuit 2E includes, instead of the inspection resistor Rts described above with reference to FIG. 15, an inspection transistor TRmo. The inspection transistor TRmo includes one conduction terminal connected to the fourth terminal Tcheck, the other conduction terminal connected to the output node N1, and a control terminal connected to the fifth terminal Ttest.

As described above, by providing the inspection transistor TRmo connected to the output node N1, during inspection, the inspection is performed in a state where the inspection transistor TRmo is turned on by applying the voltage Vtest to the fifth terminal Ttest, and when used as the electrowetting device 6, the inspection transistor TRmo is turned off so that no current flows. Note that monitoring when the electrowetting device 6 is used may be performed by turning on the inspection transistor TRmo. The inspection transistor TRmo can be formed simultaneously with the output transistor T1 and the input transistor T2.

In FIG. 18, by applying the voltage Vsel and the voltage Vdata to the third terminal Tsel and the second terminal Tdata, respectively, while applying the voltage Vp to the first terminal Tp, the input transistor T2 and the output transistor T1 are turned on. By applying the voltage Vtest to the fifth terminal Ttest, the inspection transistor TRmo is turned on, and a current flows from the first terminal Tp to the fourth terminal Tcheck via the output transistor T1 and the inspection transistor TRmo. By measuring at least one of a voltage or a current value of the fourth terminal Tcheck, it is possible to detect whether the wiring line and the transistor of the control circuit 2E are normal (presence or absence of defects).

By sequentially switching the terminals to which the voltage Vsel, the voltage Vdata and the voltage Vtest are applied, all the control circuits 2E included in the circuit substrate 1E can be sequentially inspected.

The fifth terminal Ttest in FIG. 18 is connected to a plurality of the control circuits 2E arranged in the row direction, but may be connected to the plurality of control circuits 2E arranged in the column direction, or may be drawn out from each of the plurality of control circuits 2E.

### Fifth Modified Example According to Second Embodiment

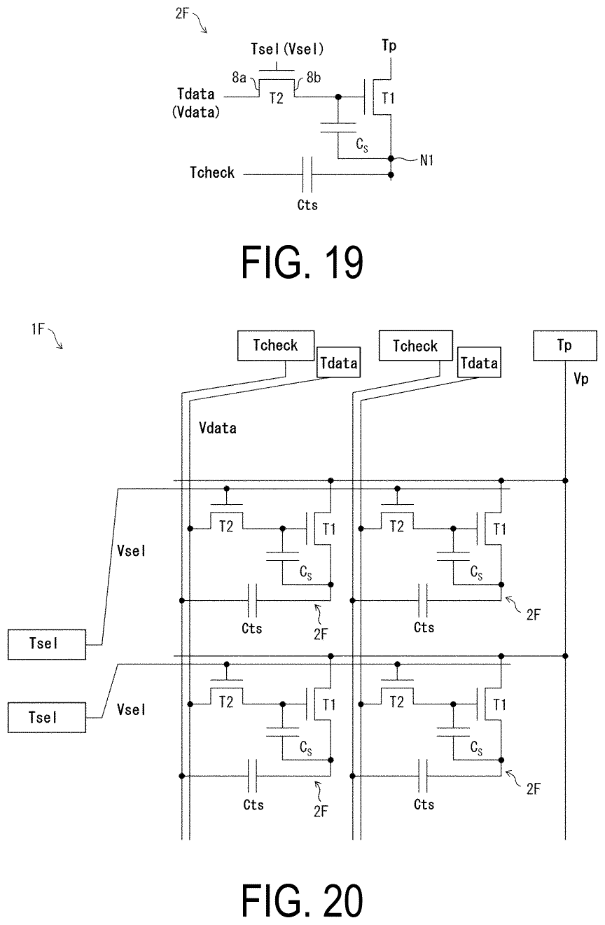

FIG. 19 is a circuit diagram of an equivalent circuit of a control circuit 2F according to a fifth modified example. FIG. 20 is a circuit diagram for explaining an operation of the control circuits 2F arranged in an array according to the fifth modified example.

As illustrated in FIG. 19, the control circuit 2F includes, instead of the inspection resistor Rts described above with reference to FIG. 15, an inspection capacitor Cts including one electrode connected to the fourth terminal Tcheck and the other electrode connected to the output node N1.

As described above, by providing the inspection capacitor Cts connected to the output node N1, during inspection, the inspection is performed by applying the voltage Vp having a frequency that passes through the inspection capacitor Cts, and when used as the electrowetting device 6, by applying the voltage Vp having a frequency that does not pass through the inspection capacitor Cts, the control circuit 2F can be used as the electrowetting device 6. The capacitance value of the inspection capacitor Cts can be adjusted by the size of the capacitance electrode and the thickness and material of the insulating film between the capacitance electrodes.

In FIG. 20, by applying the voltage Vsel and the voltage Vdata to the third terminal Tsel and the second terminal Tdata, respectively, the input transistor T2 and the output transistor T1 are turned on. By applying the voltage Vp having a frequency that passes through the inspection capacitor Cts to the first terminal Tp and measuring the current of the fourth terminal Tcheck, it is possible to detect whether the wiring line and the transistor of the control circuit 2F are normal (presence or absence of defects). When used as the electrowetting device 6, the voltage Vp having a frequency that does not pass through the inspection capacitor Cts is applied to the first terminal Tp.

### Sixth Modified Example According to Second Embodiment

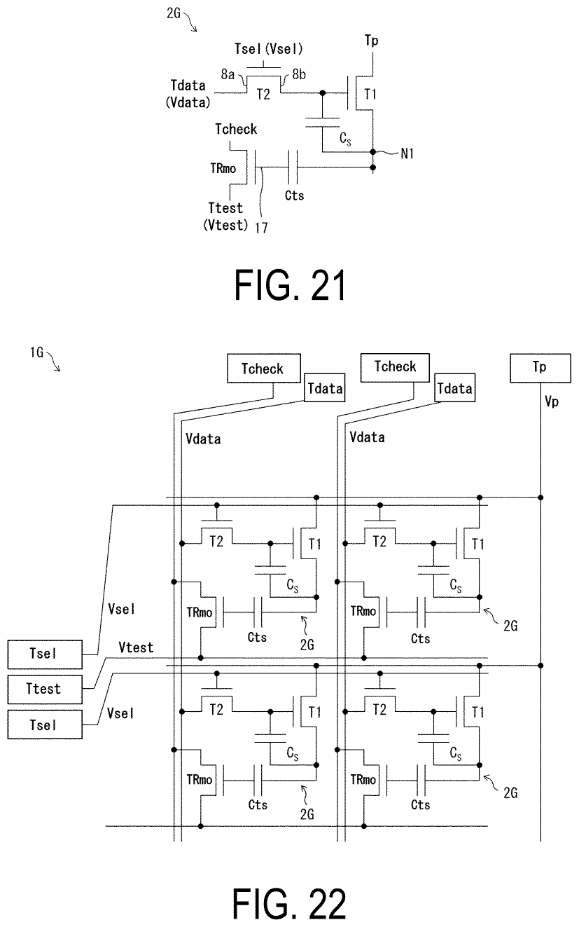

FIG. 21 is a circuit diagram of an equivalent circuit of a control circuit 2G according to a sixth modified example. FIG. 22 is a circuit diagram for explaining an operation of the control circuits 2G arranged in an array according to the sixth modified example.

As illustrated in FIG. 21, the control circuit 2G includes, instead of the inspection resistor Rts described above with reference to FIG. 15, the inspection capacitor Cts and the inspection transistor TRmo, a control terminal 17 of the inspection transistor TRmo is connected to the output node N1 via the inspection capacitor Cts, one conduction terminal is connected to the fourth terminal Tcheck, and the other conduction terminal is connected to the fifth terminal Ttest.

Accordingly, not only during inspection but also when used as the electrowetting device 6, the inspection transistor TRmo is turned on according to the charge (voltage) accumulated in the inspection capacitor Cts. Thus, the voltage Vtest flows from the fifth terminal Ttest to the fourth terminal Tcheck, and by measuring the voltage/current value, the transistor performance and presence or absence of defects of the control circuit 2G may be monitored. The capacitance value of the inspection capacitor Cts can be adjusted by the size of the capacitance electrode and the thickness and material of the insulating film between the capacitance electrodes.

In contrast to the control circuit 2E described above, the control circuit 2G is configured such that all the potentials (currents) flow to the element electrode 3 connected to the output node N1 without leaking of the voltage Vp to the fourth terminal Tcheck. Thus, the configuration illustrated in the control circuit 2G can be driven more efficiently for current monitoring when used as the electrowetting device 6.

In FIG. 22, by applying the voltage Vp to the first terminal Tp and by applying the voltage Vsel and the voltage Vdata to the third terminal Tsel and the second terminal Tdata, respectively, the input transistor T2 and the output transistor T1 are turned on, and the inspection capacitor Cts is charged. The potential charged in the inspection capacitor Cts is applied to the control terminal 17 of the inspection transistor TRmo, and the inspection transistor TRmo is turned on. At this time, by applying the voltage Vtest to the fifth terminal Ttest, a current is generated in the fourth terminal Tcheck via the inspection transistor TRmo, and by measuring at least one of the voltage or the current of the fourth terminal Tcheck, it is possible to detect whether the wiring line and the transistor of the control circuit 2G are normal (presence or absence of defects).

In FIG. 22, although the fifth terminal Ttest is connected to a plurality of the control circuits 2G arranged in the row direction and the fourth terminal Tcheck is connected to the plurality of control circuits 2G arranged in the column direction, the fifth terminal Ttest may be connected to the plurality of control circuits 2G arranged in the column direction and the fourth terminal Tcheck may be connected to the plurality of control circuits 2G arranged in the row direction. Both the fifth terminal Ttest and the fourth terminal Tcheck may be connected to the plurality of control circuits 2G arranged in the row direction or the column direction.

### Supplement

The circuit substrates 1 and 1A to 1C according to a first aspect of the disclosure are circuit substrates including the control circuits 2 and 2A to 2C each including the input transistor T2, the output transistor T1, the output node N1, and the inspection circuit elements (the inspection wiring line Ltest, the inspection resistor Rtest, the inspection capacitor Ctest, and the inspection transistor Ttest) connected to the other conduction terminal 8b of the input transistor T2 and the output node N1. The other conduction terminal 8b of the input transistor T2 is connected to the control terminal 9 of the output transistor T1. As a result, in the control circuits 2 and 2A to 2C, a current corresponding to input to the one conduction terminal 8a of the input transistor T2 flows to the first terminal 7a via the output node N1 and the output transistor T1.

According to the above configuration, it is possible to determine whether the control circuit is a non-defective product in the state of the circuit substrate.

In the circuit substrates 1 and 1A to 1C according to a second aspect of the disclosure, in the first aspect, a control circuit group including a plurality of the control circuits 2 and 2A to 2C may be provided.

According to the above configuration, it is possible to determine whether the plurality of control circuits included in the circuit substrate are non-defective products.

In the circuit substrate 1 according to a third aspect of the disclosure, in the first or second aspect, the inspection circuit element is preferably the inspection wiring line Ltest.

According to the above configuration, it is possible to determine whether the circuit substrate is a non-defective product with a simple configuration of the inspection wiring line.

In the circuit substrate 1A according to a fourth aspect of the disclosure, in the first or second aspect, the inspection circuit element is preferably an inspection resistor Rtest.

According to the above configuration, by increasing the resistance of the inspection wiring line, when the control circuit is actually used as the electrowetting device, a display device, or the like, only a current at a level that does not cause a problem in an operation can flow.

In the circuit substrate 1B according to a fifth aspect of the disclosure, in any one of the first to fourth aspects, the inspection circuit element is preferably the inspection capacitor Ctest.

According to the above configuration, during inspection, the inspection is performed with a signal having a frequency that passes through the inspection capacitor, and when used as the electrowetting device, the signal having a frequency that does not pass through the inspection capacitor can be used.

In the circuit substrate 1C according to a sixth aspect of the disclosure, in any one of the first to fifth aspects, the inspection circuit element is preferably the inspection transistor Ttest.

According to the above configuration, during inspection, the inspection is performed in a state where the inspection transistor is turned on, and when used as the electrowetting device, the inspection transistor is turned off so that no current flows.

In the circuit substrates 1 and 1A to 1C according to a seventh aspect of the disclosure, in any one of the first to sixth aspects, the control circuits 2 and 2A to 2C each preferably include the holding capacitor Cs, and the control terminal 9 of the output transistor T1 and the output node N1 are preferably connected to each other via the holding capacitor Cs.

According to the above configuration, the electric charge corresponding to input to the one conduction terminal of the input transistor can be held by the holding capacitor.

In the circuit substrates 1 and 1A to 1C according to an eighth aspect of the disclosure, in the seventh aspect, the inspection circuit element is preferably connected to the holding capacitor Cs.

In the circuit substrates 1 and 1A to 1C according to a ninth aspect of the disclosure, in any one of the first to eighth aspects, the control circuits 2 and 2A to 2C each preferably include the element electrode 3 connected to the output node N1.

According to the above configuration, the element electrode can be used as one of a pair of electrodes of the electrowetting device.

The electrowetting device 6 according to a tenth aspect of the disclosure includes the circuit substrates 1 and 1A to 1C according to the ninth aspect, the counter substrate 4 facing the circuit substrates 1 and 1A to 1C, and the conductive liquids 5 disposed between the circuit substrates 1 and 1A to 1C and the counter substrate 4.

According to the above configuration, it is possible to determine whether the plurality of control circuits included in the circuit substrate are non-defective products in the electrowetting device.

In the electrowetting device 6 according to an eleventh aspect of the disclosure, in the tenth aspect, the counter substrate 4 preferably includes the counter electrode (cathode electrode 15) facing the element electrode via the conductive liquid.

According to the above configuration, the droplet of the conductive liquid can be moved to a desired position by electrowetting.

In the electrowetting device 6 according to a twelfth aspect of the disclosure, in the eleventh aspect, a voltage corresponding to input to the one conduction terminal 8a of the input transistor T2 is preferably applied to the conductive liquid 5 between the element electrode 3 and the counter electrode (cathode electrode 15).

According to the above configuration, the droplet of the conductive liquid can be moved to a desired position by electrowetting.

In the electrowetting device 6 according to a thirteenth aspect of the disclosure, in the eleventh aspect, an ionic liquid or a polar liquid is used as the conductive liquid 5.

According to the above configuration, the droplet of the conductive liquid can be moved to a desired position by electrowetting.

The circuit substrates 1D to 1G according to a fourteenth aspect of the disclosure are circuit substrates 1D to 1G used in the electrowetting device 6 using the conductive liquid 5, and include the control circuits 2D to 2G each including the input transistor T2, the output transistor T1, and the output node N1, in which in the control circuits 2D to 2G, a current corresponding to input to one conduction terminal 8a of the input transistor T2 flows to the output node N1 via the output transistor T1, and the control circuits 2D to 2G each include the inspection circuit element (the inspection resistor Rts, the inspection capacitor Cts, and the inspection transistor TRts) connected to the output node N1 and the terminal Tcheck.

According to the above configuration, by measuring the voltage/current value of the terminal Tcheck, it is possible to detect whether the wiring lines and transistors of the control circuits 2D to 2G are normal (presence or absence of defects), and it is possible to monitor changes in the current values due to the occurrence of defects and degradation of TFT characteristics.

In the circuit substrate 1D according to a fifteenth aspect of the disclosure, in the fourteenth aspect, the inspection circuit element is preferably the inspection resistor Rst.

According to the above configuration, only by providing the inspection wiring line having a high resistance, it is possible to detect whether the wiring line and the transistor of the control circuit 2D are normal (presence or absence of a defect).

In the circuit substrate 1F according to a sixteenth aspect of the disclosure, in the fourteenth aspect, the inspection circuit element is preferably the inspection capacitor Cts.

According to the above configuration, during inspection, the inspection is performed with a signal having a frequency that passes through the inspection capacitor Cts, and when used as the electrowetting device, the signal having a frequency that does not pass through the inspection capacitor can be used.

In the circuit substrate 1E according to a seventeenth aspect of the disclosure, in the fourteenth aspect, the inspection circuit element is preferably the inspection transistor TRmo.

According to the above configuration, during inspection, the inspection is performed in a state where the inspection transistor TRmo is turned on, and when used as the electrowetting device, the inspection transistor TRmo is turned off so that no current flows. In addition, when monitoring the voltage/current during the use of the electrowetting device, the voltage/current can be monitored by turning on the inspection transistor TRmo.

In the circuit substrate 1G according to an eighteenth aspect of the disclosure, in the fourteenth aspect, the inspection circuit element preferably includes the inspection capacitor Cts and the inspection transistor TRmo, and the control terminal of the inspection transistor TRmo is preferably connected to the output node N1 via the inspection capacitor Cts.

According to the above configuration, not only during inspection but also when used as the electrowetting device, the inspection transistor TRmo is turned on according to the capacitance (voltage) accumulated in the inspection capacitor Cts. Thus, by measuring the voltage/current value of the terminal Tcheck, the transistor performance and the presence or absence of defects of the control circuit 2G can be monitored.

In the circuit substrates 1D to 1G according to a nineteenth aspect of the disclosure, in any one of the fourteenth to eighteenth aspects, the control circuits 2D to 2G each preferably include the element electrode 3 connected to the output node N1.

The electrowetting device 6 according to a twentieth aspect of the disclosure includes the circuit substrates 1D to 1G according to the nineteenth aspect, the counter substrate 4 facing the circuit substrates 1D to 1G, and the conductive liquids 5 disposed between the circuit substrates 1D to 1G and the counter substrate 4.

The disclosure is not limited to the embodiments described above, and various modifications may be made within the scope of the claims. Embodiments obtained by appropriately combining technical approaches disclosed in the different embodiments also fall within the technical scope of the disclosure. Furthermore, novel technical features can be formed by combining the technical approaches disclosed in the embodiments.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A circuit substrate comprising:
a control circuit including
an input transistor,
an output transistor, and
an output node,
wherein one conduction terminal of the input transistor is connected to a control terminal of the output transistor,
one conduction terminal of the output transistor is connected to the output node, and
the circuit substrate further includes an inspection circuit element connected to the output node.

2. The circuit substrate according to claim 1,
wherein one electrode of the inspection circuit element is connected to the one conduction terminal of the input transistor, and
the other electrode of the inspection circuit element is connected to the output node.

3. The circuit substrate according to claim 1,
wherein the control circuit includes a detection terminal,
one electrode of the inspection circuit element is connected to the output node, and
the other electrode of the inspection circuit element is connected to the detection terminal.

4. The circuit substrate according to claim 1,
wherein the control circuit includes a control circuit group provided in an array.

5. The circuit substrate according to claim 2,
wherein the inspection circuit element is any one of a wiring line, a resistor, and a capacitor.

6. The circuit substrate according to claim 3, further comprising:
a plurality of data wiring lines;
a plurality of scanning wiring lines; and
a plurality of power source wiring lines,
wherein the other conduction terminal of the input transistor is connected to any one of the plurality of data wiring lines,
a control terminal of the input transistor is connected to any one of the plurality of scanning wiring lines,
the other conduction terminal of the output transistor is connected to any one of the plurality of power source wiring lines.

7. The circuit substrate according to claim 2,
wherein the inspection circuit element is an inspection transistor,
one conduction terminal of the inspection transistor is connected to the one conduction terminal of the input transistor, and
the other conduction terminal of the inspection transistor is connected to the output node.

8. The circuit substrate according to claim 7, further comprising:
a plurality of data wiring lines;
a plurality of scanning wiring lines;
a plurality of power source wiring lines; and
a plurality of inspection wiring lines,
wherein the other conduction terminal of the input transistor is connected to any one of the plurality of data wiring lines,
a control terminal of the input transistor is connected to any one of the plurality of scanning wiring lines,
the other conduction terminal of the output transistor is connected to any one of the plurality of power source wiring lines, and
a control terminal of the inspection transistor is connected to any one of the plurality of inspection wiring lines.

9. The circuit substrate according to claim 3,
wherein the inspection circuit element is one of a resistor and a capacitor.

10. The circuit substrate according to claim 3, further comprising:
a plurality of data wiring lines;
a plurality of scanning wiring lines,
a plurality of power source wiring lines; and
a plurality of detection wiring lines,
wherein the other conduction terminal of the input transistor is connected to any one of the plurality of data wiring lines,
a control terminal of the input transistor is connected to any one of the plurality of scanning wiring lines,
the other conduction terminal of the output transistor is connected to any one of the plurality of power source wiring lines, and
the detection terminal is connected to any one of the plurality of detection wiring lines.

11. The circuit substrate according to claim 3,
wherein the inspection circuit element is an inspection transistor,
one conduction terminal of the inspection transistor is connected to the output node, and
the other conduction terminal of the inspection transistor is connected to the detection terminal.

12. The circuit substrate according to claim 11, further comprising:
a plurality of data wiring lines;
a plurality of scanning wiring lines;
a plurality of power source wiring lines;
a plurality of detection wiring lines; and
a plurality of inspection wiring lines,
wherein the other conduction terminal of the input transistor is connected to any one of the plurality of data wiring lines,
a control terminal of the input transistor is connected to any one of the plurality of scanning wiring lines,
the other conduction terminal of the output transistor is connected to any one of the plurality of power source wiring lines,
the other conduction terminal of the inspection transistor is connected to any one of the plurality of detection wiring lines, and
a control terminal of the inspection transistor is connected to any one of the plurality of inspection wiring lines.

13. The circuit substrate according to claim 3,
wherein the inspection circuit element includes an inspection capacitor and an inspection transistor,
one electrode of the inspection capacitor is connected to the output node,
the other electrode of the inspection capacitor is connected to a control terminal of the inspection transistor, and
one conduction terminal of the inspection transistor is connected to the detection terminal.

14. The circuit substrate according to claim 13, further comprising:
a plurality of data wiring lines;
a plurality of scanning wiring lines;
a plurality of power source wiring lines;
a plurality of detection wiring lines; and
a plurality of inspection wiring lines,
wherein the other conduction terminal of the input transistor is connected to any one of the plurality of data wiring lines,
a control terminal of the input transistor is connected to any one of the plurality of scanning wiring lines,
the other conduction terminal of the output transistor is connected to any one of the plurality of power source wiring lines,
one conduction terminal of the inspection transistor is connected to any one of the plurality of detection wiring lines, and
the other conduction terminal of the inspection transistor is connected to any one of the plurality of inspection wiring lines.

15. The circuit substrate according to claim 1,
wherein the control circuit includes a holding capacitor,
one electrode of the holding capacitor is connected to the control terminal of the output transistor, and
the other electrode of the holding capacitor is connected to the output node.

16. The circuit substrate according to claim 1, further comprising:
an element electrode connected to the output node.

17. An electrowetting device comprising:
the circuit substrate according to claim 1;
a counter substrate facing the circuit substrate; and
a conductive liquid disposed between the circuit substrate and the counter substrate.

18. The electrowetting device according to claim 17,
wherein the counter substrate includes a counter electrode at a position facing the element electrode.

19. A control circuit comprising:
an input transistor;
an output transistor;
a holding capacitor;
a first terminal;
a second terminal;
a third terminal; and
an output terminal,
wherein one conduction terminal of the output transistor is connected to the first terminal,
the other conduction terminal is connected to the output terminal,
one conduction terminal of the input transistor is connected to the second terminal,
the other conduction terminal is connected to a control terminal of the output transistor,
the control terminal is connected to the third terminal,
one electrode of the holding capacitor is connected to a control terminal of the output transistor,
the other electrode is connected to the output terminal, and
the control circuit further includes an inspection circuit element connected to the control terminal of the output transistor and the output terminal.

20. A control circuit comprising:
an input transistor;
an output transistor;
a holding capacitor;
a first terminal;
a second terminal;
a third terminal;
a fourth terminal; and
an output terminal,
wherein one conduction terminal of the output transistor is connected to the first terminal,
the other conduction terminal is connected to the output terminal,
one conduction terminal of the input transistor is connected to the second terminal,
the other conduction terminal is connected to a control terminal of the output transistor,
the control terminal is connected to the third terminal,
one electrode of the holding capacitor is connected to a control terminal of the output transistor,
the other electrode is connected to the output terminal, and
the control circuit further includes an inspection circuit element connected to the output terminal and the fourth terminal.
